(19) United States
(12) Patent Application Publication
(10) Pub. No.: US 2005/0105995 A1
(43) Pub. Date: May 19, 2005

(54) Internal lift for light duty motor vehicle

(75) Inventors: David W. Freet, Chandler, AZ (US); William E. Gest, Fountain Hills, AZ (US)

Correspondence Address: Paul F. Wille, 6407 East Clinton Street, Scottsdale, AZ, 85254, US

(73) Assignee: Vantage Mobility International, LLC, Phoenix, AZ (US)

(21) Appl. No.: 10/713,724

(22) Filed: Nov. 13, 2003

(51) Int. Cl. B60P 1/00

(52) U.S. Cl. 414/541

(57) ABSTRACT

A lift includes a first telescoping member including a flange for attaching the lift to a vehicle, a second telescoping member coupled to the first telescoping member, and a tool coupled to the second telescoping member, wherein the tool is movable along two orthogonal axes of motion as determined by the two telescoping members. The telescoping members include at least two nested slides. A first slide includes a first pair of rollers on one side thereof and a second pair of rollers opposite the first pair. The second slide includes a pair of opposed U-shaped channels that enclose the rollers to provide a telescoping action. If one axis of motion is vertical, a block is included between each pair of rollers. Each block is dimensioned to engage the bottom of a channel, whereby the blocks help stabilize the motion of the first slide. Motion along two axes is controlled by actuation of a single switch.

### BACKGROUND OF THE INVENTION

This invention relates to a lift for loading or unloading goods into a light duty motor vehicle such as a van, utility vehicle, minivan, or even a large scooter such as a golf cart.

A variety of small motorized scooters have been developed to carry a seated person through areas intended for pedestrian traffic. These scooters are battery powered, ride on either three or four small wheels, and are relatively compact but can be rather heavy because of the battery and electric motor. Unlike powered or unpowered wheelchairs, motorized scooters are usually not driven into a van or other vehicle with a person seated on the scooter. Rather, a lift is provided for attaching a scooter to the van for traveling long distances.

Powered wheelchairs and scooters are evolving toward each other, making terminology imprecise. One manufacturer avoids the problem and calls its product a “highly maneuverable vehicle.” Some vehicles have wheels at the corners of a rectangle with the driven axle parallel to one side of the rectangle. Other vehicles have wheels at the corners of a diamond, with the driven axle parallel to a diagonal of the diamond. As used herein, “scooter” is intended to be generic to all such vehicles for aiding a person of limited mobility.

Scooter lifts are either external, as illustrated in U.S. Pat. No. 5,011,361 (Peterson) and U.S. Pat. No. 5,567,107 (Bruno), or internal, as illustrated in U.S. Pat. No. 5,205,700 (Lin et al.) and U.S. Pat. No. 5,853,282 (Bechler et al.). External lifts typically have a fold-down platform for receiving the scooter. An internal lift is typically a small derrick mounted in the rear portion of a vehicle that hooks onto a portion of the scooter for lifting.

An exterior platform lift is typically attached to the rear of a vehicle, e.g. via a trailer hitch, and is exposed to dirt and weather. Further, such a lift increases vehicle length and substantially changes the driving characteristics of the vehicle when carrying a scooter. An interior lift typically hooks onto a scooter in two or more places but does not prevent the scooter from turning, which can make it difficult to load the scooter.

Enclosed or interior platform lifts are known the art, typically for raising an occupied wheelchair into a vehicle. Such lifts are attached to the side of a vehicle, and usually require a substantial re-working of the structure of the vehicle, e.g. replacing a portion of the frame and floor of a vehicle, as disclosed in U.S. Pat. No. 6,190,112 (Danilovic). Such lifts are quite expensive, often too expensive for those who need the lift. Enclosed platforms often take up a substantial amount of interior space, which can be a problem is smaller vehicles such as a minivan. Interior platform lifts are essentially restricted to vans and minivans. Station wagons, utility vehicles, pick-up trucks, and other light duty motor vehicles are unlikely candidates for such lifts because of lack of space or lack of weather protection.

It is known in the art to provide a platform lift with a powered, telescoping mast or column; see the Peterson patent, U.S. Pat. No. 5,984,613 (Motilewa), or U.S. Pat. No. 6,007,290 (Schulz et al.). These lifts are for scooters. Platform lifts with more than one axis of movement (vertical or z-axis) are wheelchair lifts that are part of a highly modified vehicle and typically have a scissors type of action for moving the platform vertically and rotate the platform about one end to a vertical position; e.g. see U.S. Pat. No. 4,958,979 (Svensson) and U.S. Pat. No. 6,435,804 (Hutchins). In the Svensson patent, the platform is stored under the floor of the vehicle when not lifting or lowering.

Known external platforms typically have a single side from which the platform can be entered or exited. This is needlessly inconvenient and potentially dangerous because the entrance to the platform is often on the driver's side or traffic side of the vehicle; e.g. see the Peterson patent. Another inconvenience in lifts of the prior art having more than one powered axis of movement is a control system that has a separate button for each axis. The user is challenged in some way but is assumed to have the manual dexterity of a child playing video games when operating the controls for a lift.

In view of the foregoing, it is therefore an object of the invention to provide an internal lift for light duty motor vehicles.

Another object of the invention is to provides adequate location for the goods, i.e. not letting the goods dangle on the end of a rope, during lift and storage in a vehicle.

A further object of the invention is to provide an internal platform lift that can store goods during transit.

Another object of the invention is to provide a lift having a platform that can be entered from more than one direction.

A further object of the invention is to provide a platform lift that fully retracts into a light duty motor vehicle.

Another object of the invention is to provide a lift that operates in two axes of motion with the push of a single button.

A further object of the invention is to provide an internal lift for light duty motor vehicles that does not require significant structural changes of the vehicle for installation.

### SUMMARY OF THE INVENTION

The foregoing objects are achieved in this invention in which a lift includes a first telescoping member including a flange for attaching the lift to a vehicle, a second telescoping member coupled to the first telescoping member, and a tool coupled to the second telescoping member, wherein the tool is movable along two orthogonal axes of motion as determined by the two telescoping members. The telescoping members include at least two nested slides. A first slide includes a first pair of rollers on one side thereof and a second pair of rollers opposite the first pair. The second slide includes a pair of opposed U-shaped channels that enclose the rollers to provide a telescoping action. If one axis of motion is vertical, a block is included between each pair of rollers. Each block is dimensioned to engage the bottom of a channel, whereby the blocks help stabilize the motion of the first slide. Motion along two axes is controlled by actuation of a single switch.

### BRIEF DESCRIPTION OF THE DRAWINGS

A more complete understanding of the invention can be obtained by considering the following detailed description in conjunction with the accompanying drawings, in which:

FIG. 1 is a perspective view of a lift constructed in accordance with a preferred embodiment of the invention and located in the rear portion of a minivan;

FIG. 2 is a perspective view of a lift constructed in accordance with a preferred embodiment of the invention, showing the lift head fully extended horizontally and the platform fully extended vertically;

FIG. 3 is a perspective view of a lift constructed in accordance with a preferred embodiment of the invention, showing the lift head fully retracted horizontally and the platform fully retracted vertically in a minivan;

FIG. 4 is a perspective view of the lift head constructed in accordance with an alternative embodiment of the invention, wherein the platform is replaced by a box for holding goods;

FIG. 5 is a perspective view of the lift head constructed in accordance with an alternative embodiment of the invention, wherein the platform is replaced by a fork for holding goods on a pallet;

FIG. 6 is a detail of a roller and track mechanism for moving the lift head horizontally;

FIG. 7 is a detail of a roller and track mechanism for moving the lift head horizontally;

FIG. 8 is a detail of a roller and track mechanism for moving the lift head horizontally;

FIG. 9 is a perspective view of the telescoping mast fully retracted;

FIG. 10 is a perspective view of the telescoping mast partially extended;

FIG. 11 is a perspective view of the telescoping mast fully extended;

FIG. 12 is a perspective view of the telescoping mast with cut-aways showing the roller and track mechanism for guiding the mast sections;

FIG. 13 is a rear perspective view of the telescoping mast with a cut-away showing the powered capstan for raising the mast sections;

FIG. 14 is a perspective view of the telescoping mast with cut-aways showing the roller and track mechanism in greater detail;

FIG. 15 is a perspective view of the powered screw for moving the lift head horizontally;

FIG. 16 is a perspective view of the trapped nut and release mechanism attached to the lift head;

FIGS. 17-20 are block diagrams of a circuit for providing single button control of the lift; and

FIG. 21 is a block diagram of a microprocessor based circuit for providing single button control of the lift.

### DETAILED DESCRIPTION OF THE INVENTION

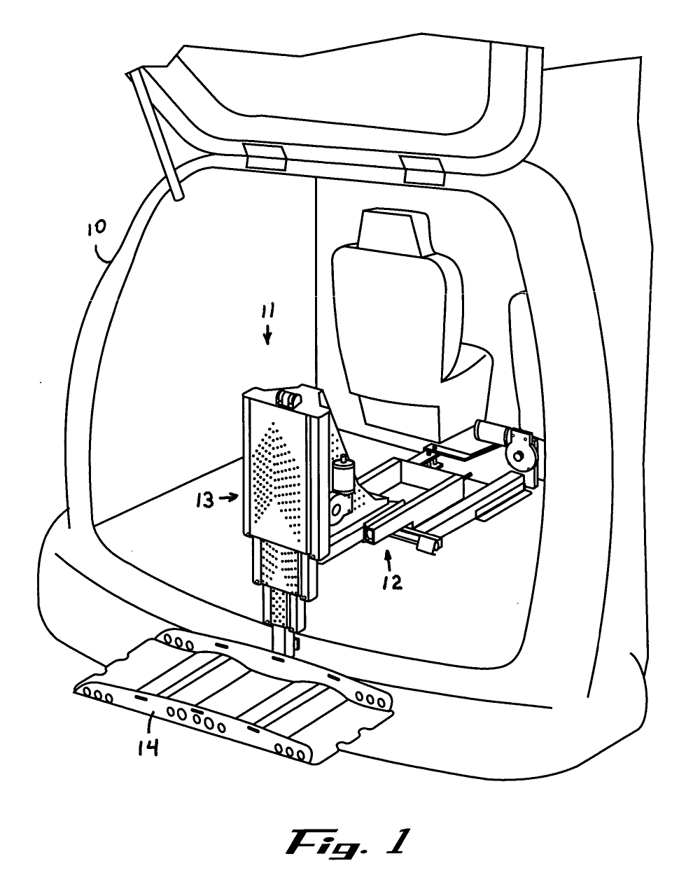

FIG. 1 is a perspective view of a lift constructed in accordance with the invention and mounted in a light duty motor vehicle, represented by minivan 10. Lift 11 includes two telescoping members, horizontally telescoping member 12 and vertically telescoping mast 13. The lower portion of vertically telescoping mast 13 is attached to platform 14. As illustrated in FIG. 1, platform 14 is adapted to receive a motorized scooter. As further described below, a variety of tools can be attached to the moving end of vertically telescoping mast 13 to adapt the lift to a wide variety of tasks.

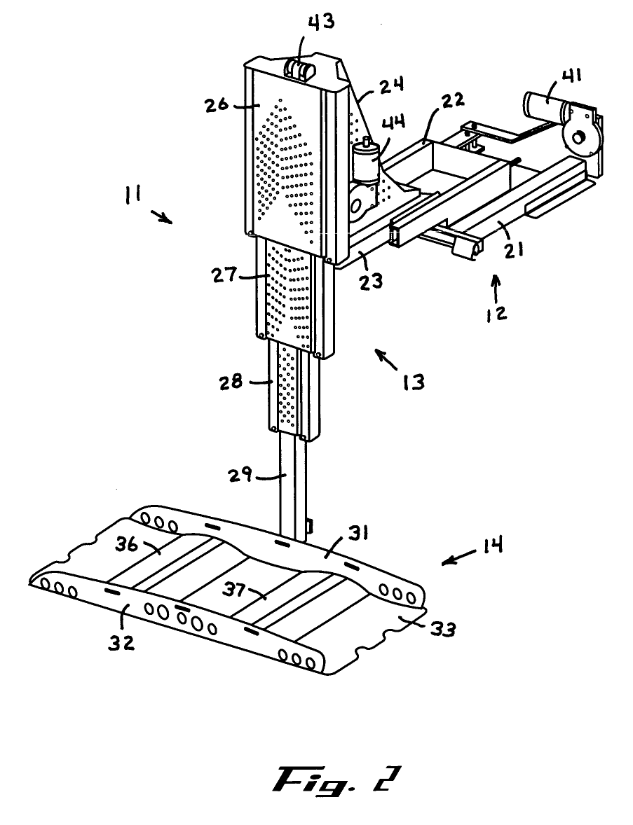

FIG. 2 illustrates lift 11 fully extended horizontally and vertically. Horizontally telescoping member 12 includes base 21, middle slide 22, and inner slide 23 including head 24 to which vertically telescoping mast 13 is attached, preferably by welding. Vertically telescoping mast 13 includes base unit 26, first slide 27, second slide 28, and end post 29. For both members, the slides are hollow and nest within one another, like little boxes, to provide a compact but sturdy support. As described in detail below, each box has pairs of wheels on opposite sides thereof, near one end, to support the box and provide the telescoping action.

In accordance with another aspect of the invention, platform 14 can be entered from either end. Platform 14 includes first wall 31 and second wall 32 on opposite sides of floor 33. The ends are open, enabling entry from either end. This provides a great convenience for the user and eliminates the risk associated with entering the platform from the traffic (left) side of the platform. Floor 33 includes raised, transverse portions 36 and 37 for locating a scooter centrally on the platform. With the wheels locked, a scooter is relatively securely located for transit. A plurality of apertures in walls 31 and 32 provide attaching points for tie downs to further secure a scooter.

The telescoping action can be powered by pneumatic, hydraulic, or other means. In a preferred embodiment of the invention, horizontal telescoping member 12 is powered by a threaded shaft powered by electric motor through suitable reduction gearing. Vertical telescoping member 13 is powered by woven tape 43 wound on a capstan (not shown in FIG. 2) powered by electric motor 44 through suitable reduction gearing.

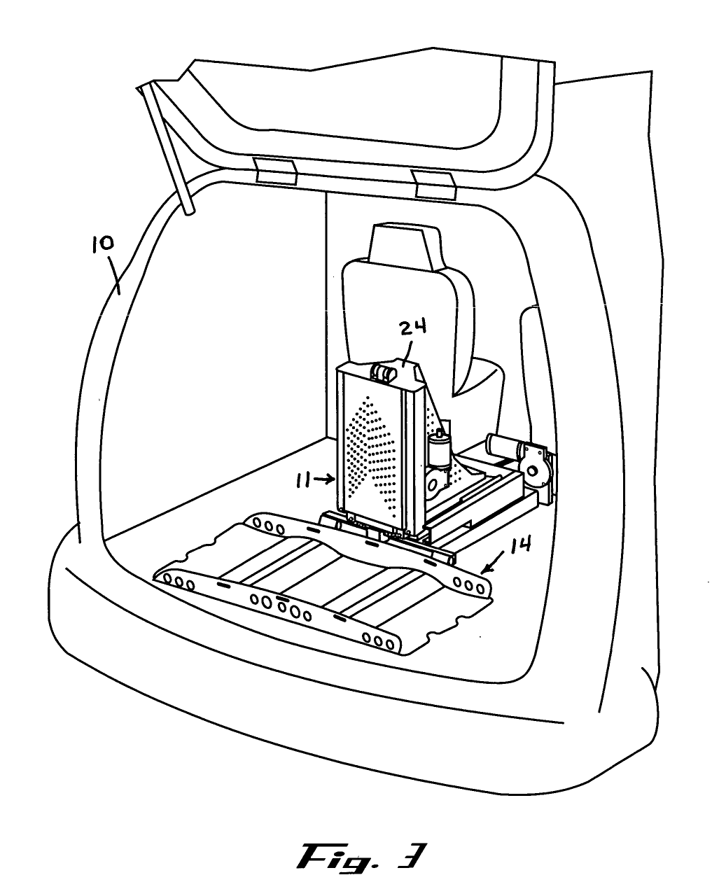

FIG. 3 is a perspective view of lift 11, showing platform 14 fully raised and head 24 fully retracted in minivan 10. Depending upon application, one could rotate platform 14 about the rear edge to obtain even more compact storage. As it is, lift 11 and whatever cargo or goods may be on platform 14 are fully contained within minivan 10, providing secure, protected storage during transport.

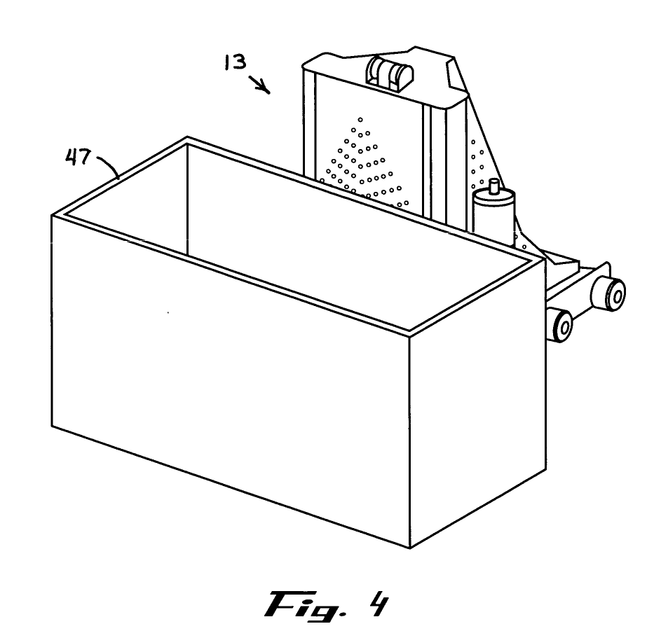

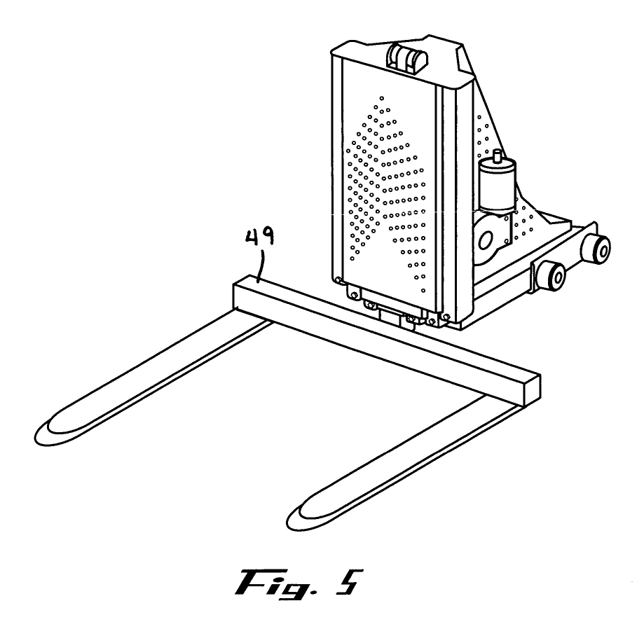

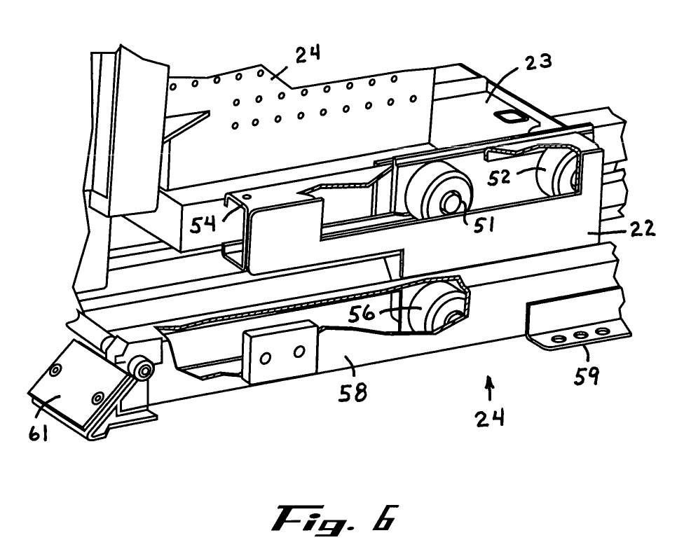

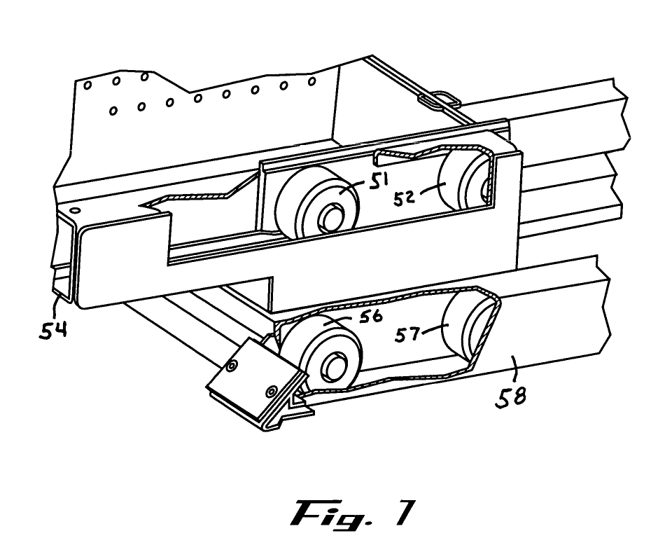

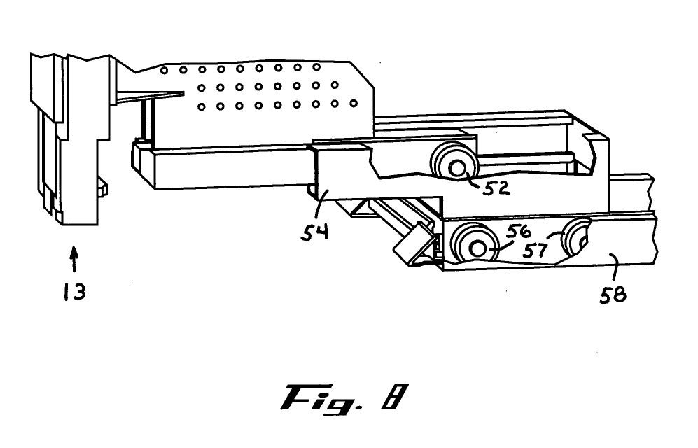

FIG. 4 is a perspective view of an alternative embodiment of the invention, wherein platform 14 is replaced by box 47 for holding goods. Box 47 is suitably attached to the end post of vertically telescoping mast 13 by welding or other means. Box 47 can be provided with suitable skids or feet (not shown) for engaging the floor of the minivan to prevent rocking during transport.

FIG. 5 is a perspective view of an alternative embodiment of the invention, wherein platform 14 is replaced by fork 49 for holding goods on a pallet. From these alternative embodiments, one can see that a great variety of tools can be attached to the vertically telescoping member in accordance with the invention. It is not intended to name them all individually but all are intended to be covered by the claims that follow.

FIGS. 6, 7, and 8 illustrate details of a roller and track mechanism for moving the lift head horizontally. FIG. 6 illustrates the mechanism fully retracted. Head 24 is attached to inner slide 23, which is supported on each side by at least a pair of rollers, such as rollers 51 and 52 within U-shaped channel 54. Channel 54, in turn, is attached to middle slide 22, which is supported on each side by at least a pair of rollers, including roller 56 within U-shaped channel 58. Channel 58 is attached to the floor or, preferably, the frame of the vehicle by angle bracket 59. Angle bracket 59 is preferably welded to channel 58 and includes a plurality of holes for bolting the lift to the floor of a vehicle or through the floor to the frame or other structural member, such as a crossbeam, of a vehicle. Stop block 61 provides a mechanical stop for a tool attached to the lift and prevents damage to the horizontal telescoping member when the tool is fully retracted.

FIG. 7 illustrates the horizontal telescoping member partially extended. Rollers 56 and 57 are at the end of their travel in channel 58 but rollers 51 and 52 are not at the end of their travel in channel 54. In FIG. 8, the horizontal telescoping member is fully extended. Rollers 56 and 57 are at the end of their travel in channel 58 and roller 51 (not shown in FIG. 8) and roller 52 are at the end of their travel in channel 54. At this point, mast 13 extends past the bumper of the vehicle to provide ample clearance for vertical movement of the telescoping mast.

Because the rollers are attached at the rear of the slides, the front roller of each pair engages the lower side of a U-shaped channel and the rear roller of each pair engages the upper side of each U-shaped channel. Preferably, the rollers are pre-loaded, e.g. roller 51 is mounted slightly lower than roller 52, to hold the slides approximately horizontal.

FIGS. 9, 10, and 11 illustrate the movement of telescoping mast 13. Base unit 26 is attached to head 24, preferably by welding. A single, cast unit could be used instead. In FIG. 9, telescoping mast 13 is fully retracted or raised. In this position, the mast clears the floor of the vehicle for retraction into the vehicle, despite the considerable length of the mast when extended.

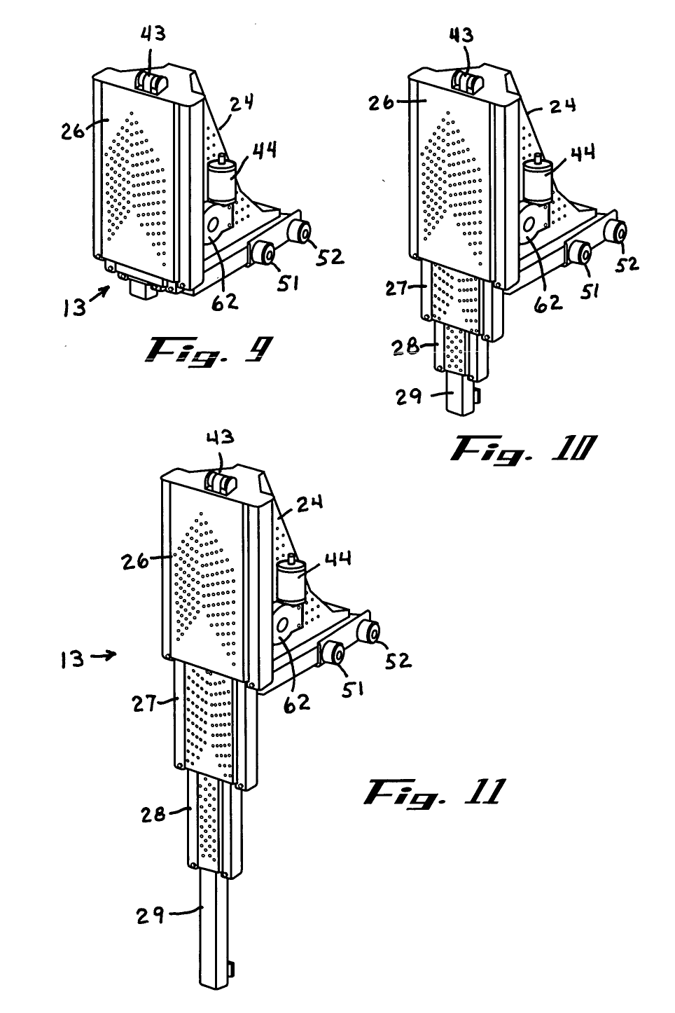

FIG. 10 illustrates mast 13 partially extended. Depending upon the internal construction of the mast, all sections may not extend together, as shown in FIG. 10. Tape 43 is attached at one end to end post 29. First slide 27 and second slide 28 rest on their stops (not shown in FIG. 10) and thus move with end post 29 until the slides encounter their respective stops at the upper end thereof. In this way, end post 29 does not extend until after second slide 28 extends, which is not until after first slide 27 is fully extended. Thus, the weakest part of the mast is not extended until last. By “weakest” is meant the ability to resist torque about a vertical centerline of mast 13. Beca use the slides are wider, they resist torque better.

In a preferred embodiment of the invention, gravity is used to lower the sections of the mast under the control of tape 43, motor 44, reduction gear 61, and a capstan or drum (not shown) coupled to reduction gear 61. That is, motor 44 provides a force that opposes gravity to a greater or lesser degree for retracting or extending mast 13.

Reduction gear 44 provides a secondary function in that the mast cannot drive motor 44 through the reduction gear. Thus, when motor 44 stops, the mast is effectively locked by the reduction gear. In theory, the mast could be retracted by an external force but such external force is unlikely and would have to be substantial, particularly if a load were held in a tool on the end of mast 13.

A tape drive has a further advantage in that, if the vehicle is parked on uneven ground, end post 29 simply stops when it encounters an obstacle because it is not being driven downward. Suitable control circuitry, not part of this invention, senses current through motor 44 and shuts off the motor if too much or too little current is drawn; the latter being the case when end post 29 encounters an obstacle.

FIG. 11 illustrates mast 13 fully extended. If there is sufficient room, end post 29 is fully extended until an internal stop (not shown in FIG. 11) is encountered. Slides 27 and 28 are also fully extended. In this position, in one embodiment of the invention, the lower end of end post 29 extends more than three feet below the level of the surface to which channel 58 (FIG. 6) is attached.

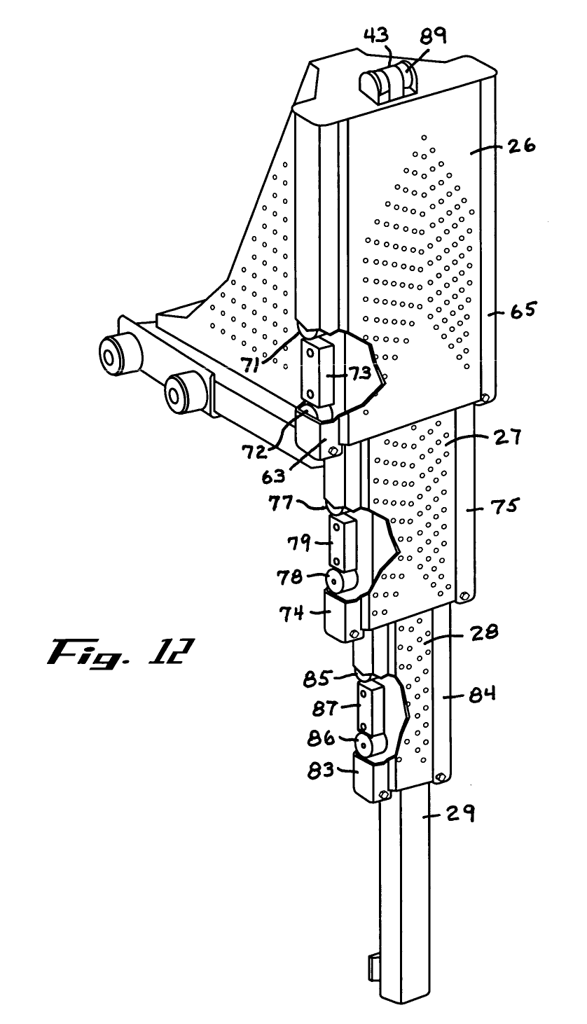

The long reach and sturdiness of telescoping mast 13 is due in part to the materials from which it is made (preferably steel) and in part to the internal design, which also provides a chatter free, smooth operation that is tight (small dimensional tolerances) without excessive friction. FIG. 12 illustrates the channel and roller construction in cut-away. The construction of the sections of mast 13 are essentially symmetrical about a vertical centerline. Thus, only the left side of the mast is shown in cut-away and described in further detail.

Base unit 26 includes opposed U-shaped channels 63 and 65 on either side of the base unit. The channels are opposed in the sense that the open parts of the channels face each other. Within channel 63 are roller 71, roller 72, and block 73, all attached to first slide 27. Block 73 is preferably made from Teflon®, Delrin® or other suitable, low friction material. Rollers 71 and 72 have a width that is slightly less than the width of block 73. Block 73 and the corresponding block in channel 65 are spaced to engage the bottom (of the U) of each channel. Rollers 71 and 72 engage one side of channel 63 and block 73 engages the other side of the channel to pre-load the rollers. Thus, the rollers can turn freely within channel 63. A third roller could be used to pre-load rollers 71 and 72 but block 73 is less expensive and just as effective. The combination provides a tight but chatterless movement. Another advantage of this design is its resistance to dirt and contamination. The unit can provide many years of trouble free, maintenance free service unless used in an extremely dirty or hostile environment.

In theory, the friction of the rollers and blocks is a blessing when extending the mast and a burden when retracting the mast. In fact, the friction is so small compared with the weight of the components that friction is insignificant.

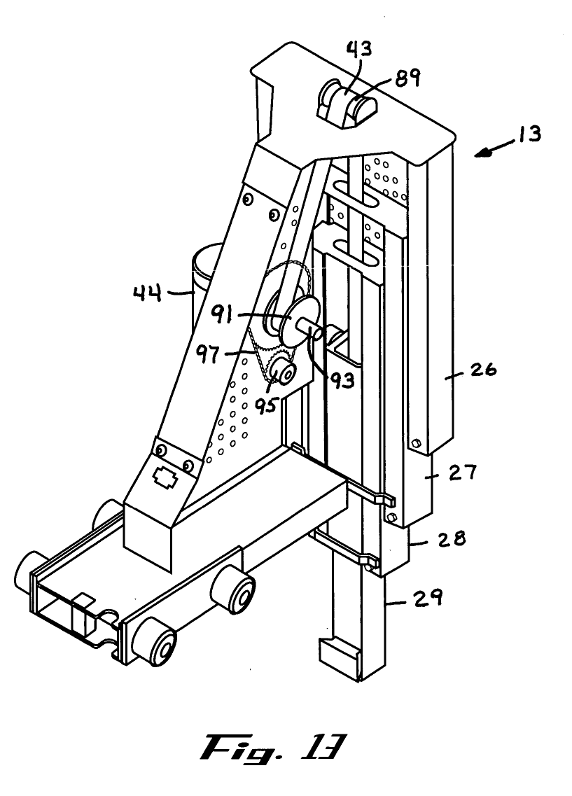

The remainder of mast 13 is similarly constructed. First slide 27 includes opposed U-shaped channels 74 and 75 attached to opposite edges of the slide. Within channel 74 are roller 77, roller 78, and block 79, all attached to second slide 28. Second slide 28 includes opposed U-shaped channels 83 and 84 attached to opposite edges of the slide. Within channel 83 are roller 85, roller 86, and block 87, all attached to end post 29. End post 29 is attached to an end of woven tape 43, which is wound over sheave 89. The drive mechanism for tape 43 is illustrated in FIG. 13.

In FIG. 13, woven tape 43 is wound around capstan 91 on shaft 93, the number of turns depending upon whether mast 13 is retracted or extended. The free end of tape 43 passes over sheave 89 and extends down through openings in base unit 26, first slide 27, second slide 28, and is attached to end post 29. Capstan 91 is coupled to electric motor 44 by at least one gear reduction mechanism. In a preferred embodiment of the invention, motor 44 is coupled to shaft 95 by reduction gear 62 (FIG. 11), which is preferably a worm driven gear to provide the locking effect described above. Shaft 95 is coupled to shaft 93 to by chain drive 97, which also provide some gear reduction and an efficient coupling of power.

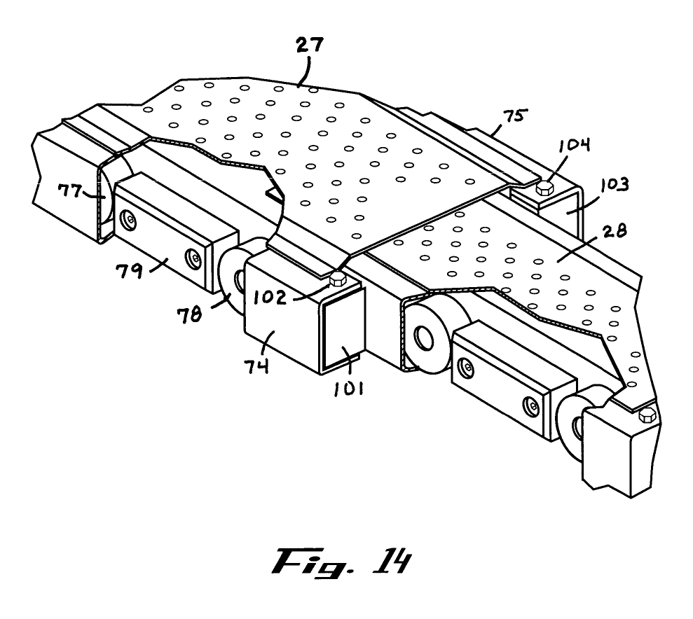

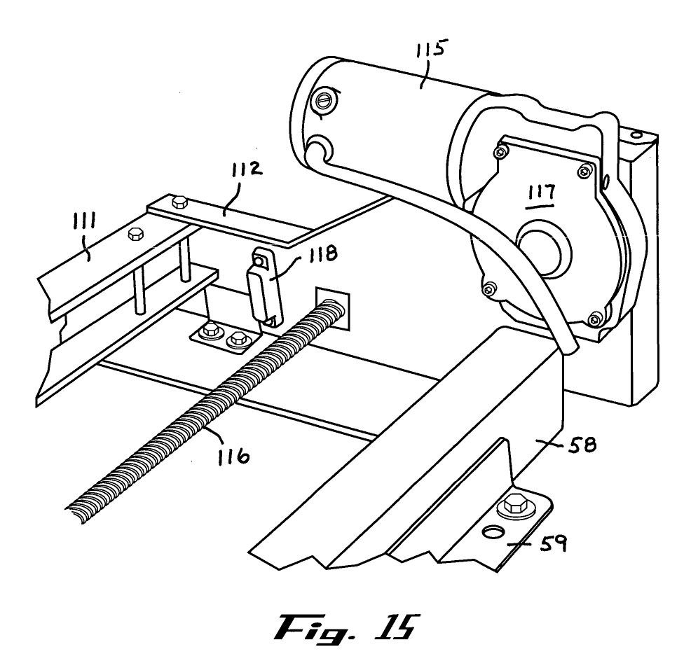

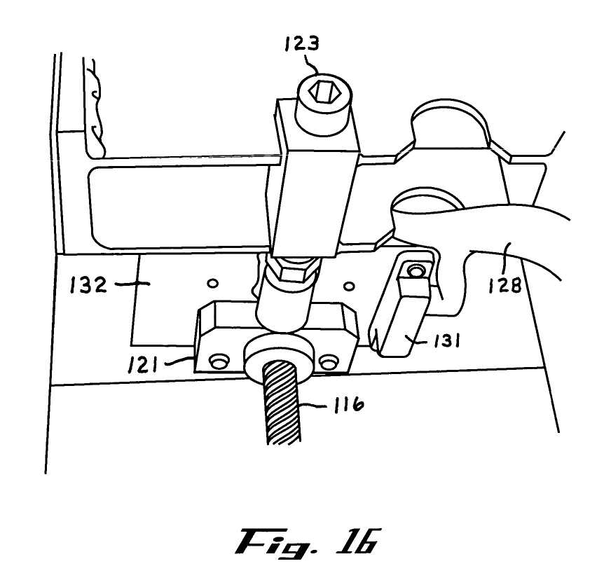

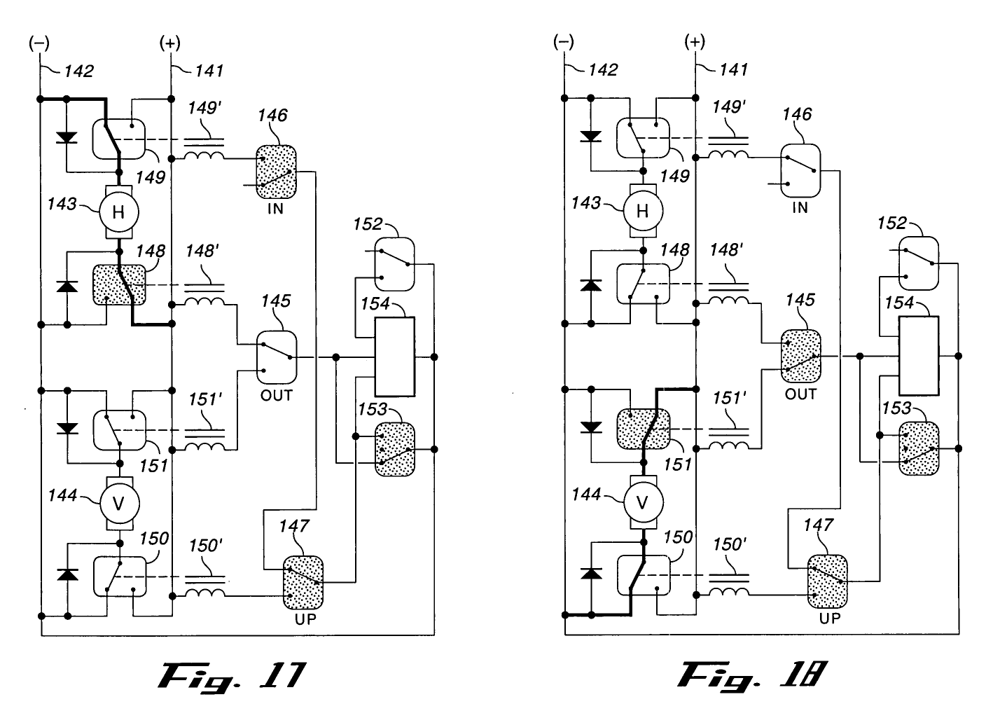

FIG. 14 illustrates the channel and roller construction in greater detail. Channel 74 contains roller 77, roller 78, and block 79, as described above. In order to prevent second slide 28 from dropping out of first slide 28, channel 74 also includes stop block 101 held in place at the lower end of the channel by bolt 102. Similarly, stop block 103 is located at the end of channel 75 and is held in place by bolt 104. Stop blocks 101 and 103 have a secondary function of preventing dirt and debris from entering the channels. The ends are not sealed as such but the parts fit closely enough to keep the internal components clean.

FIG. 15 illustrates the drive mechanism for horizontally telescoping member 12 (FIG. 2). Channel 58 is attached to the floor of the vehicle by angle bracket 59, as described above. Opposing channel 111 is also attached to the floor of the vehicle. At the ends of the channels, cross-member 112 is attached, holding the channels in fixed spatial relationship when the lift is not attached to a vehicle. Also attached to cross-member 112 is electric motor 115 coupled to threaded shaft 116 by reduction gear 117 and a chain drive (not shown) behind cross-member 112. Reduction gear 117 is preferably a worm gear, which has the secondary benefit of locking threaded shaft 116. The chain drive provides further reduction, high coupling efficiency, and isolates the output shaft in reduction gear 117 from loads imposed on threaded shaft 116. The whole drive mechanism is also relatively flat, with electric motor 115 being the thickest element. Thus, a minimum amount of room is taken up by the drive mechanism.

Magnet 118 is also mounted on cross-member 112 and actuates limit switch 131 (FIG. 16) when inner slide 23 (FIG. 6) is fully retracted. Limit switch 131 is one of a plurality of sense switches used in the lift but which, in themselves, are not part of the invention.

Threaded shaft is coupled to head 24 (FIG. 6) by a split nut and bearing assembly illustrated in FIG. 16. Threaded shaft 116 enters block 121, which contains the split nut (not shown), which is held against shaft 116 by bolt 123. Split nut assemblies are known in themselves in the art. In accordance with another aspect of the invention, bolt 123 is readily accessible and easily loosened to release the split nut, enabling head 24 to move freely should that ever become necessary.

Limit switch 131 is mounted on panel 132 and senses when inner slide 23 (FIG. 6) is fully retracted. Another limit switch, not shown, behind panel 132, senses when the inner slide is fully extended. Flexible cable 128 contains a plurality of wires for controlling the operation of head 24. One can control the lift with a hand held unit coupled to the lift by wire or by radio emission, as used for locks in an automobile. Cabling puts all the wires in a common sheath and improves the appearance of the lift.

In accordance with another aspect of the invention, a single button controls the motion of the lift along two axes of movement. This can be accomplished with a few mechanical switches, relays, and some diodes for protection or under microprocessor control with semiconductor switches. FIGS. 17, 18, 19, and 20 are block diagrams of the same circuit for controlling motion along two orthogonal axes using mechanical switches and relays. Different aspects of the circuit are emphasized in the figures.

In FIG. 17, rail 141 is coupled to the positive (+) terminal on a battery (not shown) and rail 142 is coupled to the negative (−) terminal on the battery. DC electric motor 143 drives horizontally telescoping member 12 and DC electric motor 144 drives telescoping mast 13. In one embodiment of the invention, the rails are coupled to the DC motors through four relays, 148, 149, 150, and 151 for reversing the polarity of the voltage applied to each DC motor, thereby individually reversing the direction of rotation of the output shaft of each motor.

Either single pole, double throw (SPDT), center-off, operator switch 153 or remote control 154 controls direction (extension and retraction). Block 154 represents the receiver portion of the remote control. The handheld transmitter is not shown. Movement along each axis is determined, in part by the positions of the OUT limit switch 145, IN limit switch 146, up limit switch 147, OUT relay 148, IN relay 149, UP relay 150, and DOWN relay 151. The remote lockout feature is determined by LOCKOUT limit switch 152. Each limit switch and relay is a SPDT switch, although one throw on switch 146 and 152 is not used.

FIG. 17 illustrates the state of the lift when horizontal telescoping member 12 is fully retracted and telescoping mast 13 is fully raised; i.e. platform 14 (FIG. 3) is raised and stowed in the vehicle. Thus, the OUT limit switch is not actuated, as indicated in FIG. 17 by the absence of stippling.

If switch 153 is thrown to the extend position or an extend button (not shown) on remote control 154 is actuated, then current flows from rail 141 through relay coil 148′, through switch 145, and through either switch 153 or remote control 154 to rail 142. Relay coil 148′ is magnetically coupled to the throw in switch 148, pulling the throw to the right, coupling motor 143 to rail 141. Current flows along the path indicated in heavier line from rail 141, through switch 148, through motor 143, through switch 149 to rail 142. Motor 143 turns, causing horizontally telescoping member 12 (FIG. 1) to extend.

When horizontally telescoping member 12 reaches a fully extended position, OUT limit switch 145 is actuated, opening the circuit through relay coil 148′, causing the throw in switch 148 to revert to the left hand position, disconnecting motor 143 from rail 141 and connecting motor 144 to rail 142. At this point, the horizontal telescoping member is fully extended and the telescoping mast is fully raised.

Now current flows from rail 141 through relay coil 151′, through switch 145, and through either switch 153 or remote control 154 to rail 142. Relay coil 151′ pulls the throw in switch 151 to the right, connecting motor 144 to rail 141. As descent begins, up limit switch changes poles, with no effect as it is presently out of the circuit.

When vertical telescoping member 13 (FIG. 1) reaches the intended down position (the ground), the operator releases switch 153 to its normal center position or releases the button on remote control 154, deactivating relay coil 151′ and allowing switch 151 to revert to its normal left hand position, which disconnects motor 144 from rail 141. The platform is now fully extended and lowered.

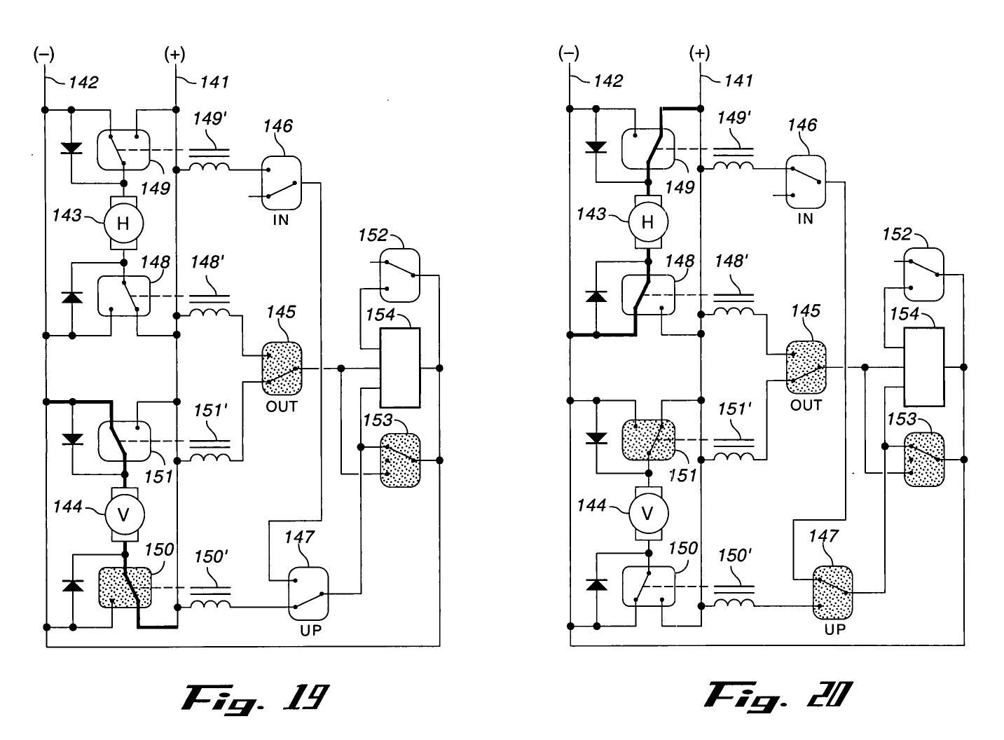

FIG. 19 illustrates the state of the lift when the platform is fully extended and lowered. Thus, up limit switch 147 is not actuated, as indicated in FIG. 19 by absence of stippling. Thus, switch 147 reverts to the position shown, coupling relay coil 150′ to switch 153 and control 154.

If switch 153 is thrown to the retract position or a retract button on remote control 154 is actuated, current flows from rail 141 through relay coil 150′, through switch 147, and through either switch 153 or remote control 154 to rail 142. Current through relay coil 150′ causes switch 150 to change poles, coupling motor 144 to rail 141. Current flows through motor 144 in the circuit indicated in heavier line, which is in the opposite direction to the current shown in FIG. 18. Thus, motor 144 raises the platform, collapsing telescoping member 13 (FIG. 1).

As soon as vertical telescoping member 13 (FIG. 1) reaches a fully raised position, as determined by up limit switch 147, the switch is actuated, opening the circuit through relay coil 150′, causing switch 158 to revert to the left hand pole, and disconnecting motor 144 from rail 141.

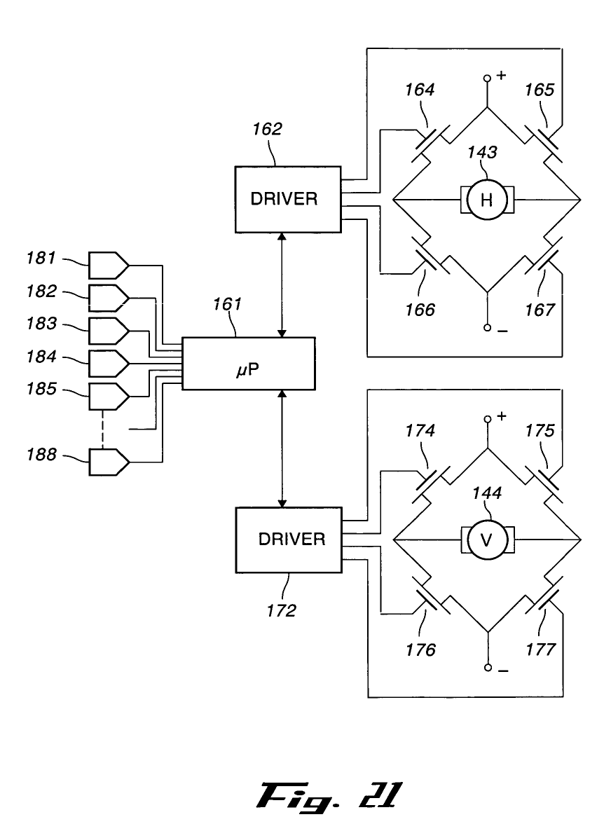

At this point, the horizontal telescoping member is fully extended and the telescoping mast is fully raised. The circuitry is in the state shown in FIG. 20. When switch 147 changes poles, current flows from rail 141 through relay coil 149′, through switch 146, through switch 147, and through either switch 153 or remote control 154 to rail 142. Current through relay coil 149′ causes switch 149 to change poles, coupling motor 143 to rail 141. Current flows through motor 143 as indicated by the heavier line, which is opposite to the direction of the current flow illustrated in FIG. 17. Thus, motor 143 retracts the platform into the vehicle.

When horizontal telescoping member 12 (FIG. 1) reaches its innermost position as determined by IN limit switch 146, the switch is activated, disconnecting relay coil 149′, which deactivates switch 149 and disconnects motor 143 from rail 141. Thus, by actuating a single switch, a user can extend or retract the telescoping mast and the horizontal telescoping member in the correct sequence.

Changing ones mind in the middle of an operation simply reverses the process. For example, starting at the state shown in FIG. 17, after the telescoping horizontal member has, partially extended, IN limit switch has changed poles. Reversing operator switch 153 simply puts the control into the state shown in FIG. 20 and the telescoping horizontal member retracts.

FIG. 21 illustrates a control circuit implemented with semiconductor switches. This is not to say that there are no mechanical switches in a lift constructed in accordance with the invention. Mechanical switches remain useful as “fail-safe” devices. This aspect of the invention concerns single button operation, not other safety considerations. Computerized control facilitates making changes and adding features without having to modify hardware.

In FIG. 21, microprocessor 161 is coupled to motor 143 by driver 162 and what is known as an H-bridge including switching transistors 164, 165, 166, and 167. A DC diagonal of the bridge is coupled to a batter, indicated by the plus sign (+) and the minus sign (−). Motor 143 is coupled to the AC diagonal of the bridge. The bridge acts a double pole, double throw switch by turning on the switching transistors in opposed arms to apply current in either direction through motor 143. Specifically, when transistors 164 and 167 conduct, current flows from left to right through motor 143. When transistors 165 and 166 conduct, current flows from right to left through motor 143.

Microprocessor 161 is also coupled to motor 144 by driver 172 and an H-bridge including transistors 174, 175, 176, and 177. Microprocessor 161 includes a plurality of inputs coupled to a plurality of sensors, represented by blocks 181, 182, 183, 184, 185 and 188. Such sensors can be electrical, optical, or mechanical and include the control buttons operated by a user. Such sensors provide information on the location of inner slide 23 (FIG. 6) and end post 29 (FIG. 10), as the limit switches 145-148 do in the embodiment of FIG. 17. Microprocessor 161 is programmed to read the sensors and activate the drivers to extend or retract the lift by applying current to motors 143 and 144 in the proper sequence and direction.

The invention thus provides an internal lift for a light duty motor vehicle that fully retracts into the vehicle. The lift provides adequate location for the goods, i.e. not letting the goods dangle on the end of a rope, during lift and storage in a vehicle, and can store goods during transit. When used as a scooter lift, the lift includes a platform that can be entered from more than one direction. Further, the lift operates in two axes of motion with the push of a single button. A lift constructed in accordance with the invention does not require significant structural changes of the vehicle for installation, that is, no changes beyond drilling bolt holes and some minor re-wiring.

Having thus described the invention, it will be apparent to those of skill in the art that various modifications can be made within the scope of the invention. For example, in some applications, the telescoping mast could extend upward rather than downward, e.g. on vehicles having “barn doors” on the rear of the vehicle rather a lift gate or on vehicles having a large opening for a side door. Instead of moving vertically, the telescoping mast could move horizontally (sideways, orthogonal to the in and out movement of the head), e.g. for depositing a load beside the vehicle and over a curb from a position at the rear of the vehicle. A continuous drive, e.g. a chain or belt, can be used instead of a tape drive or a screw drive. The number of slides in a member is a design choice depending upon application. Either chain drive or both chain drives could be eliminated for direct or geared drive. One could replace a simple DPDT switch with a DPDT stepper switch (on-off-on-off) to provide what is literally a single button control for the embodiment of FIGS. 17-21.

1. In a light duty motor vehicle having a body attached to a floor and enclosing a protected volume, said vehicle further including at least one door, in addition to a door for a driver of the vehicle, to provide access to the protected volume, the improvement comprising:
a lift including a first telescoping member coupled to said vehicle within said protected volume;
a second telescoping member coupled to said first telescoping member; and
a tool coupled to said second telescoping member;
wherein the tool is movable along two orthogonal axes of motion.

2. The vehicle as set forth in claim 1; wherein said lift is attached to the floor of the vehicle.

3. The vehicle as set forth in claim 1 wherein said tool is a platform adapted to receive a powered scooter.

4. The vehicle as set forth in claim 3 wherein said platform can be entered from at least two directions.

5. The vehicle as set forth in claim 3 wherein said platform can be entered from opposite directions.

6. The vehicle as set forth in claim 1 wherein said two axes of motion are defined by said first telescoping member and said second telescoping member.

7. The vehicle as set forth in claim 6 wherein one of said axes is horizontal.

8. The vehicle as set forth in claim 7 wherein the second of said two orthogonal axes is vertical.

9. The vehicle as set forth in claim 1 wherein said lift fits within said protected volume when both of said telescoping members are fully retracted.

10. The vehicle as set forth in claim 1 wherein at least one of said telescoping members includes at least two nested slides.

11. The vehicle as set forth in claim 10 wherein
a first slide includes a first pair of rollers on one side thereof and a second pair of rollers on a side opposite the first side;
the second of said two nested slides includes a pair of U-shaped channels on opposite sides thereof; and
said channels enclose said rollers to provide said telescoping action.

12. The vehicle as set forth in claim 11 wherein
said first slide includes a first block on one side thereof and a second block on a side opposite the first side;
said channels enclose said blocks;
said blocks are dimensioned to engage the bottom of the U in said U-shaped channels, whereby said blocks help stabilize the motion of said first slide.

13. The vehicle as set forth in claim 12 wherein said first block is located between said first pair of rollers and said second block is located between said second pair of rollers.

14. The vehicle as set forth in claim 10 wherein:
a first slide includes a first block on one side thereof and a second block on a side opposite the first side;
the second of said two nested slides includes a pair of opposed U-shaped channels on opposite sides thereof; and
said channels enclose said blocks;
said blocks are dimensioned to engage the bottom of the U in said U-shaped channels, whereby said blocks help stabilize the motion of said first slide.

15. The vehicle as set forth in claim 1 and further including:
a first motor coupled to said first telescoping member for moving said member along a first axis of motion;
a second motor coupled to said second telescoping member for moving said member along a second of said two orthogonal axes of motion;
a control circuit including a first switch, said control circuit driving said motors in the correct direction and sequence for operation in said two axes of motion by actuation of said switch.

16. A lift for a light duty motor vehicle having a body attached to a floor, said lift comprising:
a first telescoping member including a flange for attaching said lift to said vehicle without significant structural changes said vehicle;
a second telescoping member coupled to said first telescoping member; and
a tool coupled to said second telescoping member;
wherein the tool is movable along two orthogonal axes of motion.

17. The lift as set forth in claim 16 wherein said tool is a platform adapted to receive a powered scooter.

18. The lift as set forth in claim 17 wherein said platform can be entered from opposite directions.

19. The lift as set forth in claim 16 wherein one of said axes is horizontal.

20. The lift as set forth in claim 19 wherein the second of said two orthogonal axes is vertical.

22. The lift as set forth in claim 16 wherein at least one of said telescoping members includes at least two nested slides.

23. The lift as set forth in claim 22 wherein
a first slide includes a first pair of rollers on one side thereof and a second pair of rollers on a side opposite the first side;
the second of said two nested slides includes a pair of U-shaped channels on opposite sides thereof; and
said channels enclose said rollers to provide said telescoping action.

24. The lift as set forth in claim 23 wherein
said first slide includes a first block on one side thereof and a second block on a side opposite the first side;
said channels enclose said blocks;
said blocks are dimensioned to engage the bottom of the U in said U-shaped channels, whereby said blocks help stabilize the motion of said first slide.

25. The lift as set forth in claim 24 wherein said first block is located between said first pair of rollers and said second block is located between said second pair of rollers.

26. The lift as set forth in claim 22 wherein:
a first slide includes a first block on one side thereof and a second block on a side opposite the first side;
the second of said two nested slides includes a pair of U-shaped channels on opposite sides thereof; and
said channels enclose said blocks;
said blocks are dimensioned to engage the bottom of the U in said U-shaped channels, whereby said blocks help stabilize the motion of said first slide.

27. The lift as set forth in claim 16 and further including:
a first motor coupled to said first telescoping member for moving said member along a first axis of motion;
a second motor coupled to said second telescoping member for moving said member along a second of said two orthogonal axes of motion;
a control circuit including a first switch, said control circuit driving said motors in the correct direction and sequence for operation in said two axes of motion by actuation of said switch.

28. The lift as set forth in claim 27 wherein said first switch is coupled to a microprocessor.
